(19) United States
(12) Patent Application Publication
(10) Pub. No.: US 2020/0264585 A1
(43) Pub. Date: Aug. 20, 2020

(54) Methods and Systems for Control of 3D Printing

(71) Applicant: John Oliver RYAN, Woodside, CA (US)

(72) Inventor: John Oliver RYAN, Woodside, CA (US)

(21) Appl. No.: 16/790,496

(22) Filed: Feb. 13, 2020

Related U.S. Application Data
(60) Provisional application No. 62/805,733, filed on Feb. 14, 2019.

(51) Int. Cl. G05B 19/4099; B33Y 30/00; B29C 64/393; B33Y 50/02

(52) U.S. Cl. CPC G05B 19/4099; B33Y 30/00; G05B 2219/35134; B33Y 50/02; G05B 2219/49007; B29C 64/393

(57) ABSTRACT

A system and method are provided for implementing control of the 3D printing of an object by a 3D printer. The method includes providing 3D printing apparatus comprising a controller and a 3D printing module. A digital print file (DPF) representative of the object to be printed, including layer by layer information, is provided to the printing apparatus and to the controller, details of objects pre-defined as subject to printing control are also provided to the controller. The digital print file is processed to provide a representation of the object to be printed which is then interrogated to determine whether there a possible match between the features of the object to be printed and features of an object predefined as subject to print control. Printing is interrupted if it is indicated that the object to be printed has been determined to show a possible match to features to an object pre-defined as subject to print control.

### CROSS-REFERENCE TO RELATED APPLICATIONS

This application claims priority to U.S. Provisional Application No. 62/805,733 filed Feb. 14, 2019 by John Ryan entitled, “Methods and Systems for Control of 3D Printing”, which is incorporated by reference herein as if reproduced in its entirety.

### TECHNICAL FILED OF THE DISCLOSURE

The present specification relates to 3D printing machines and methods for printing 3D objects. In a preferred arrangement the specification relates to methods for preventing or controlling the 3D printing of objects which are pre-defined as controlled or prohibited objects in a particular 3D printing environment or setting.

### BACKGROUND

Rapid prototyping is defined as computer-controlled additive fabrication, in that an object can be fabricated by the addition of material rather than conventional machining methods that rely on removal or the subtraction of material. The term “rapid” is, it will be appreciated, a relative term but one that has specific meaning within the art, in that construction of finished three-dimensional articles can take from several hours to several days, depending on the method used and the size and complexity of the model, but considerably less time than it would take to make a similar part using conventional methods, (moulds, for example).

3D printing techniques involves the use of a three-dimensional (3D) computer aided design (CAD) of an object/part to be made, from which a stereo-lithography (STL) file, or other suitable format file is generated within a CAD package. It has been highlighted in recent years in the media, that attempts have been made to create controlled or otherwise licenced or prohibited devices, such as for example, firearms or other weapons, or other items subject to control (e.g. copyright control), by 3D printing. Therefore, there is a growing need to develop methods and systems to prevent the printing of such controlled or prohibited devices on a 3D printer.

In one previous approach to restrict the printing of weapons a digital certificate rights management system was used which was external to the 3D printers themselves. However, such encryptions can be bypassed.

The present specification is directed to providing methods and systems to control 3D printing of weapons or other prohibited devices or of other objects for example subject to copyright control.

### SUMMARY

In a first arrangement there is provided a 3D printing method which provides for interrogation of the actual 3D file which has been sent to the printer for printing, before enabling printing.

The 3D printing file is interrogated to search for pre-defined known geometries which point to features of a device which has been indicated as controlled or prohibited.

In another arrangement of the present specification, the name of a received input file to be printed is checked against the names of controlled or prohibited files (the names of the controlled or prohibited files may be stored in a central repository and for downloading for example via the internet), and in the event of a match or close match, printing of the object specified by the file is stopped or paused pending receipt of permissions from a supervisor.

It is anticipated that 3D printing will find many applications in schools and offices and the ability to prevent the printing of objects pre-defined as subject to print control, for example, weapons in such environments is a major objective of the method and system of this specification.

### BRIEF DESCRIPTION OF THE DRAWINGS

FIG. 1 shows a block diagram which includes steps of an exemplary method of the present specification;

FIG. 2 relates to an example of the method of the present specification and shows the cross section of a 2D profile with a suspected internal bore of a known gun barrel bore for a 0.30 calibre rifle or handgun;

FIG. 3 relates to an example method (also considered in FIG. 1) and provides for interrogation of straight or curvature of the object or portion of the object to be printed;

FIG. 4 is a block diagram of a possible exemplary 3D printer according to the present specification; and

FIG. 5 is a block diagram of a 3D printer of an exemplary arrangement in communication with a store that provide details of files indicated as subject to a print control.

### DETAILED DESCRIPTION

The present specification provides system and methods for controlling printing of received 3D digital print files otherwise referred to as 3D printing files—which are received at the printer for use by the printer to generate a 3D object. In the specification, files which are subject to a print control have been variously described as prohibited files, as files relating to prohibited objects (the printing of the object is subject to a control by the printer user), as files subject to print control, and as predefined objects which have been indicated as prohibited or controlled for printing or objects subject to control etc. The print control in effect provides a file, or representations of an object to be printed, will be reviewed so that printing of an object pre-defined as controlled can be prevented. If a file or representation is flagged for review by a supervisor because some possibly suspicious features have been identified during analysis of the file, then printing may be interrupted so that the file or representation can be further analysed and printing controlled in so far as approval would be required to allow printing to proceed. Examples of the objects include weapons or objects subject to copyright or other protection. In the present specification it has been described that data relating to files subject to control is stored—for example—there is provided a store of names of files that have been indicated as being subject to a print control—the store may be remote, local or cloud based and while described as a store may be one or more of the above. Similarly, there may be provided details of features of objects subject to control accessible by the printer or controller. In each case, the printer performs a comparison of features of a received input file with details of files or objects that have been indicated as subject to print control.

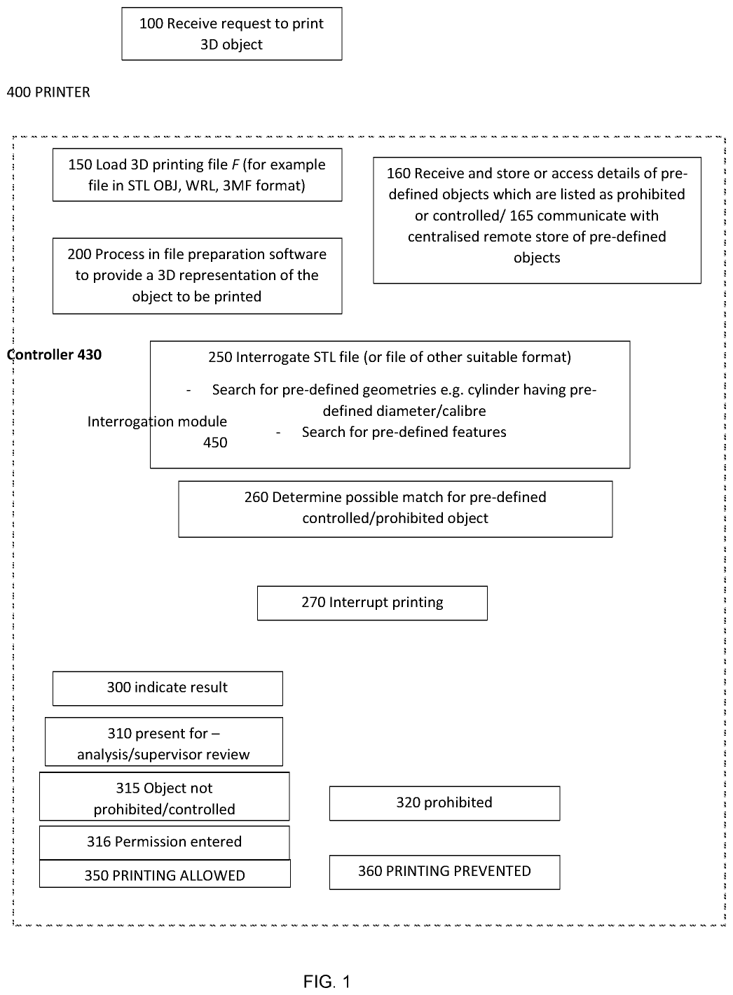

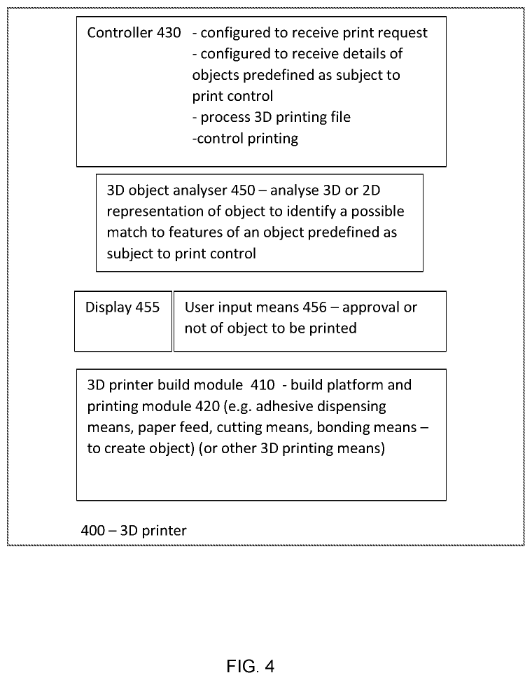

In an exemplary method of the specification, and with reference to the drawings and initially FIGS. 1 and 4, a request 100 to print a 3D object is received at the 3D printer 400. The 3D printer 400 of the exemplary arrangement further comprising a build module 410 for the layer by layer manufacture of a 3D object. The 3D printer 400 comprising a controller or processor 430 for controlling the 3D printer.

The 3D printer 400 of the present specification further includes a 3D object analyser (3D object interrogation module) 450. 3D printing techniques involve the use of a three-dimensional (3D) computer aided design (CAD) of an object/part to be made, from which a stereo-lithography (STL) file, or, other suitable format file is generated within a CAD package. In the exemplary method the 3D input digital print file (3D printing file) F is provided 150 to the 3D printer 400.

The 3D digital print file F 150 is processed 200 in the printer 400. The 3D printing file F provides in effect details of the object to be printed virtually sliced in the Z-axis at a thickness matching the thickness of the substrate material used. This creates a series of cross sections of the part and at any particular height each one has a simple two-dimensional (2D) profile. In more detail, the processing 200 includes in the controller/processor 430 taking the file type for example STL (or Wavefront Technologies' OBJ, Virtual Reality Modelling Language (WRL), 3D Manufacturing Format (3MF), etc.) and rebuilding the part to be 3D printed in the software.

There now exists a 3D representation of the part to be 3D printed in the file preparation software. This part can now be manipulated, scaled, moved, coloured etc. Before the part is printed, the geometry may be sliced into layers which is sent to the 3D printer. After the layers are sliced, the geometry is represented by a series of Two Dimensional (2D) profiles.

The method 250 and system (3D object analyser 450) of the present application provide an interrogation means for analysing the 2D profiles to establish and measure the characteristics of all lines to verify if they represent the geometries of a pre-defined prohibited object.

In an alternative approach, the interrogation means 250/450 may be configured to interrogate the 3D model before it is sliced.

The 3D printer 400 includes details and/or has access to 160/165 details of predefined objects which are indicated as prohibited or controlled for printing.

A local supervisor may indicate objects as prohibited or controlled for printing to the system. In addition, or alternatively, the printer may be configured to communicate with a remote database having details of objects indicated as prohibited or controlled for printing. Details of characteristics, typical features or attributes of objects that are prohibited or subject to control, are provided to the system.

The method 250 provides for the interrogation of the STL file (or file of suitable alternative format). The file is interrogated to search for predefined geometries and features. If a first suspicious feature is indicated, the method may provide for further interrogations of the suspicious feature. In some cases, it is determined 260 by the 3D object analyser 450 in the course of performing a feature analysis that a possible match for a prohibited object has been made. The possible match may indicate a feature that is considered suspicious and requires further consideration. Such a feature may be evaluated to see if printing should be finally prevented or if printing can be allowed to proceed. Printing may be interrupted 270.

The system may indicate 300 the results of the determination. The results may be displayed on display 455. The results may be presented 310 for review by a supervisor.

If the supervisor review determines 315 that the object is not prohibited or controlled, it is possible to enter permission 316 to indicate that the printing is allowed and for the printing of the 3D object to proceed 350. Alternatively, if the supervisor review determines 320 that the object is prohibited, the printing may be prevented 360.

FIG. 4 shows in block the arrangement of an exemplary 3D printing system.

In an exemplary arrangement the 3D printing module or build module 410 may include an adhesive dispensing means for dispensing controlled amounts of adhesive to each layer of the object, bonding means for bonding the plurality of layers, and cutting means for cutting the profile of each layer. The 3D printer 400 comprises a controller or processor 430 for controlling the 3D printer. The 3D printer 400 of the present specification further includes a 3D object analyser (3D object interrogation module) 450. The system may further include a display 455 and a user input means 456.

However, it will be appreciated that the current method and system, which provides for analysis of a representation of the object to be printed, identification of features that may indicate that the object has been predefined as a controlled object, may be used with any suitable 3D printing device.

### EXAMPLE 1

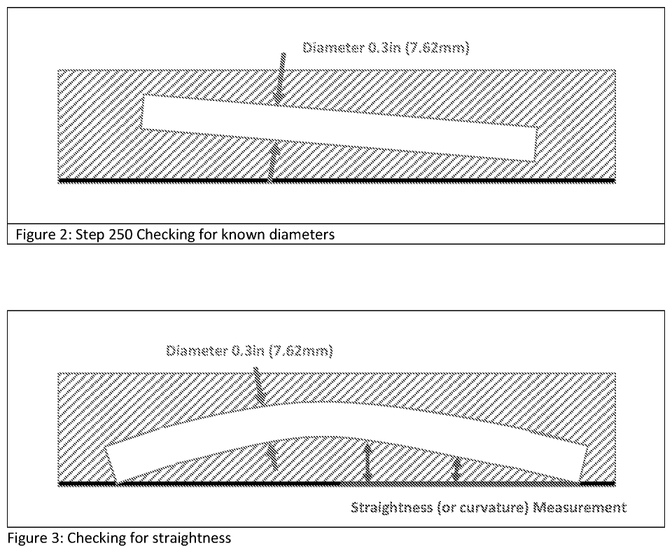

For example, with reference to FIGS. 2 and 3 a method to prevent the 3D printing of guns is described. The method includes interrogating a received 3D print file F for predefined features, for example, such as a cylinder or barrel having a pre-defined diameter or dimensions. The method provides for preventing the 3D printing of an object falling within with scope of the definition of a prohibited object.

FIG. 2 relates to a method according to the specification for interrogating the 3D printing file to identify the possible presence, for example, of a cylinder or barrel having bore characteristics of a 0.30-calibre rifle or handgun in a 3d model or object that has been sent to the printer to be printed.

The received 3D print file F 150 is opened up in the 3D file preparation software or controller 430 prior to 3D printing the object. The controller 430 or the file preparation software takes the various known file types (STL, OBJ, WRL, 3MF, etc.) and rebuilds the part to be 3D printed in the software in digital representation.

There now exists a 3D representation of the part to be 3D printed. The controller may provide display of the object. This part or object can now be manipulated, scaled, moved, coloured, etc. Before the part or object is printed, the geometry may be sliced into layers which are sent to the 3D printer. After the layers are sliced, the geometry is represented by a series of Two Dimensional (2D) profiles.

The 3D object analyser 450 then analyses and interrogates these 2D profiles to establish and measure the characteristics of all lines to verify if they represent the geometries of a weapon, for example a handgun or a knife.

In another approach, the 3D object analyser 450 would interrogate the 3D model before it is sliced.

FIG. 2 below shows the cross section of a 2D profile with a suspected internal bore of a known gun barrel bore for a 0.30 calibre rifle or handgun. Once this is detected it would be flagged in the system by the 3D object analyser 450 as a possible match so that printing can be prevented.

However, in the present exemplary method of the case of the received 3D print file F relating to an object predefined as prohibited and being a gun barrel, the diameter is one feature to be considered in the 3D object analysis. Another further consideration could be to determine whether the object to be printed is also straight or has a straight portion of dimensions suitable for application in the example of the pre-defined prohibited object. If the further analysis was to find that the object indicated as suspicious in the first analysis due to the presence of a cylinder having a diameter of 0.3 in (7.62 mm) was found in the second analysis to be curved to an extent that would negate its value as a gun barrel, then printing of the object would be allowed to proceed. FIG. 3 illustrates an internal bore equivalent to a 0.30-calibre handgun, but it's obviously curved and not straight, this would then be ignored by the algorithm.

The above example relates to the identification and control of printing in relation to guns or firearms, which as noted would subject to the methods and systems of the present specification be identifiable by the presence of a barrel with defined internal diameter.

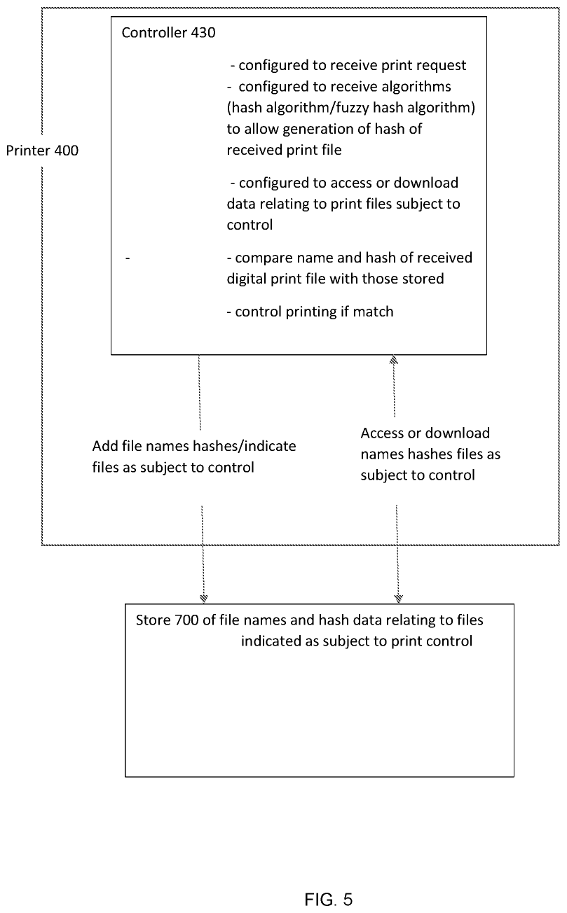

In a further aspect and with reference to the exemplary arrangement of FIG. 5 the specification also provides a method for the identification of other items the printing of which the owners of 3D printers may wish to prohibit, but which are not identifiable, on the basis of specific features having specific dimensions, for example, copyrighted designs of toys or art objects. In many cases, these items will be identified by a file number or name and the file describing the object may be legally or illegally uploaded to the Internet.

In one approach, it is provided that names of files, indicated as being subject to a print control may be added to a store or repository 700, stored locally or remotely or in the cloud, and accessible by the printer directly or via a communication networks.

For example, the files may relate to printing of an object subject to copyright. When a new 3D digital print file F 150 is received for printing at a 3D printer 400, the exemplary method provides in a first determination step—comparing the name of the file to be printed with names of files in the store (indicated as subject to a print control) and if the name of the file to be printed matches the name of a file in the store, (indicated as being subject to control), then the printer would refuse to print the object described by the file name.

However, noting a potential weakness of this approach is that a file name control might be circumvented by renaming the file before inputting to the printer for printing, the present specification provides a method and system to address this issue with reference to FIG. 5.

The method includes performing a hash of a 3D digital print file, which has been indicated as being subject to print control data and storing the hash in the file store or repository. Hash functions are generally designed to produce a unique hash even for large files differing by as little as one bit, their main purpose being to determine if a file has been modified. The hashes may be stored in an external database, external memory, or in printer memory.

In this exemplary method it is provided that the algorithms for generating the hash functions are provided to the printing system or the controller 430 of the 3D printing system. When the printer is subsequently instructed to print a first input file, the method provides performing an identical hash on the first input file data and comparing that hash to the database of hashes of files which have been indicated as subject to a print control. If a match is found, printing may be interrupted pending supervisor instruction, or may be simply prohibited.

Noting a further issue that a user wishing to circumvent the above control on printing might arrange to make a small change to the file that might make no functional difference to the printed object, but which would cause the printer to calculate a different hash value. The method of the specification further provides utilising a “fuzzy” hashing algorithm, also known as a fuzzy extractor.

The fuzzy hashing algorithm produces the same hash value for data sets that may be significantly different, but which would nevertheless command the printer to build objects that are in at least some important respects identical to the original protected object.

The method therefore provides means to identify a file which would cause a 3D printer to print an inconsequential variation of a prohibited or restricted object, by utilising a hashing function that produces the same hash value for a file that would cause a 3D printer to build an object similar to or the same as the original protected object.

In one application of this concept, the 3D printer manufacturer might generate a database of these fuzzy hashes representing prohibited objects, and arrange to download these hashes on a regular basis to 3D printers or databases in the possession of its customers. The print controller 430 performing the method to compare the name and hash and/or fuzzy hash of a received digital print file with a repository of those of files subject to print control, may also be configured to access the repository via communication networks to access the data to allow for a comparison.

Advantageously, the methods and systems of the exemplary arrangement of the present specification are that each 3D printer stores both the names of—and the fuzzy hashes of—prohibited files. The hashes may be provided from an external source, which may be the 3D printer manufacturer or even an entity wishing to protect its designs from being copied on 3D printers.

The information or data relating to name of files and fuzzy hashes of files indicated as being subject to a print control could be stored for access by the printer (for example in the cloud or other store) or could be available for download and storing in the printer or a local database.

According to an exemplary method when a printer is asked to print an object, it would first generate a hash of that object's file and then compare that hash with all hashes stored in its memory or the relevant connected memory, and on finding a match, would interrupt or prohibit printing.

The method provides the printer owner the option of preventing the printing of certain files of interest to them locally—therefore the arrangements of the specification includes providing the printer owner with the appropriate algorithms to allow them to generate the hashes of those files and input them to the printer.

The 3D printer 400 of an exemplary arrangement comprises printing apparatus for 3-D printing an object comprising:
a build module 410, having a build platform
a print module 420;
   (including for example an adhesive application means, a cutting means, a bonding means or other printing means);
a controller 430 configured to receive a digital print file (F) 150 which includes data representative of the object to be printed, including layer by layer information;
the controller 430 further configured to receive details of object which are predefined as subject to print control;
the controller 430 further comprising a 3D object analyser 450;
wherein the controller is configured to build a 3D representation of the object to be 3D printed; and
(i) wherein the 3D object analyser is configured to interrogate the representation of the object to be 3D printed to determine whether the object includes any features of the pre-defined controlled objects; or
(ii) wherein the 3D object is processed by the controller to slice into layer data to be sent to the 3D printer (the geometry being represented by a series of Two Dimensional (2D) profiles) and wherein the 3D object analyser is configured to interrogate the representation of the object to be 3D printed to determine whether the object includes any features of the pre-defined controlled objects;
if it is determined by the 3D object analyser (450) that the object to be printed may include one or more features that correspond to features of a pre-defined controlled object; the controller is configured to (i) effect further analysis and/or (ii) interrupt printing.

An exemplary method of the present specification provides a method for printing a 3D object:
providing 3D printing apparatus having a printing module and build module;
providing medium to form the layers of the object;
providing digital print file (DPF) representative of the object to be printed including layer by layer information to printing apparatus;
providing details of pre-defined controlled objects;
processing the digital print file to provide a representation of the object to be printed;
interrogating the representation of the object to be printed to determine whether there are any features present that may indicate printing of an object predefined as controlled;
interrogating for the representation of the object to determine whether further features are present that may indicate printing of an object predefined as controlled; and
interrupting printing.

In a further aspect, there is provided a method identifying print requests and digital print file pertaining to objects predefined as subject to print control but which do not include identifiable object features or dimensions.

An exemplary method of the present specification provides a method for printing a 3D object:
providing 3D printing apparatus having a controller, a printing module and build module and comprising a controller 440 configured to receive a digital print file (F) which includes data representative of the object to be printed, including layer by layer information;
   the controller further configured to receive details of objects which are predefined as subject to print control;
providing a store of the names and the hashes of the digital print files pertaining to objects pre-defined as subject to print control in external or internal memory; (the memory may be remote, cloud based or local, accessible by the controller)
providing to the 3D printing apparatus algorithms to enable the printer to generate a hash of a received/input 3D digital print file.
upon receipt at the printer of a print request and an input digital print file (DPF) representative of an object to be printed;
performing a hash on the received input digital print file;
comparing the hash of the input digital print file with the stored digital print file hashes;
determining whether a match is found between the hash of input digital print file and the stored digital print file hashes pertaining to objects predefined as controlled; and
interrupting printing if a match between the hashes is found

The interrupting printing may include prompting for review from a supervisor.

The supervisor may enter approval to allow printing to proceed.

If no approval is provided printing may be prevented.

In the method, the hash function may be used to determine if the file received in a print request from a user has been modified.

The method may provide a fuzzy hashing algorithm or fuzzy extractor such that the fuzzy hashing algorithm is configured to produce the same hash value for data sets or digital print files that may be significantly different, but which are directed to command the printer to build objects that are in at least some important respects identical to the original protected object/the object pre-defined as subject to a print control.

The method provides means to identify a file which is directed to printing a prohibited or restricted object on the basis that the algorithm produces the same hash value for a data file directed to build an object similar to or the same as the original protected object. The method therefore allows control of printing based on the object.

The present specification provides a system and methods for implementing a control of 3D printing at the point of printing.

It will be appreciated that the methods described are complementary and may be combined and used together in a method that includes interrogating the image files, and for the comparison of file name data and comparison of hash data.

The control is an intelligent control that provides for interrogation of the data of the object to be printed to determine whether there are present therein “suspicious features” or features that indicate a possible match to an object that has been predefined as subject to print control.

The level of control to be implemented by the system can be selected by a supervisor with authority and means to decide what may be printed by the printers under his supervision. The system can be set to determine the possible match for a combination of features of an object predefined as subject to control, as set out in the example of FIGS. 2 and 3.

If a possible match is indicated, such can be displayed to a supervisor user while printing is interrupted. The supervisor may be prompted to input a confirmation that printing is prevented or that printing can resume.

The object analyser can be provided in software form and can be implemented in a variety of 3D printing systems. The name and hash and fuzzy hash generator and analyser can be provided in software form and can be implemented in a variety of 3D printing systems. It will be appreciated that the systems and methods may include both the object analyser and name and hash and fuzzy hash analyser.

The system and method provide for further safety and security while reducing requirements on the user or printer operator. The system and method can interrogate beyond the final appearance of an object to determine whether a final printed object could be modified after printing to arrive at an object predefined as subject to print control. By providing for interrogation of the print file, the method is more thorough and provides a higher level of control than prior methods.

It will be appreciated that the systems and methods of the present specification may be applied to any 3D printing arrangement, such as for example 3D printers as made by CleanGreen3d.

What is claimed is:

1. A method for controlling the 3D printing of an object by a 3D printer:
providing 3D printing apparatus comprising a controller and a 3D printing module;
providing a digital print file (DPF) representative of the object to be printed, including layer by layer information, to the 3D printing apparatus and to the controller;
providing details of objects pre-defined as subject to print control to the controller;
processing the digital print file to provide a representation of the object to be printed;
interrogating the representation of the object to be printed;
determining whether there a possible match between the features of the object to be printed and features of an object predefined as subject to print control;
indicating that the object to be printed has been determined to show a possible match to features of an object pre-defined as subject to print control;
interrupting printing.

2. The method of claim 1 further comprising the displaying an indication that an object to be printed has been determined to show a possible match to features pre-defined as subject to print control.

3. The method of claims 1 further comprising receiving confirmation that printing is allowed whereupon the controller instructs the 3D printing module to print the object, or, that printing is prevented.

4. The method of claim 3 wherein the confirmation is provided by a supervisor.

5. The method of claim 1 wherein if the determining finds a possible match that indicates the presence of one feature or attribute of an object predefined as subject to control, further interrogating the representation of the object to determine whether a second feature of an object subject to print control is present.

6. The method of claim 5 wherein if first and second features of an object subject to print control are not present, printing is resumed.

7. The method of claim 1 further comprising the controller analysing details of objects predefined as subject to printing control to distil out first and possible second or more additional features to be searched for when interrogating a representation of an object to be printed, to determine a possible match between the object to be printed and an object predefined as subject to print control.

8. The method of claim 1 wherein providing details of objects pre-defined as subject to print control to the controller further comprises:
providing to the controller access to the names of digital print files pre-defined as subject to print control;
comparing the name of a received digital print file provided to the 3D printer for printing with the names of files subject to print control, and if the name of the digital print file matches the name of a file pre-defined as subject to print control to determine whether the digital print file name matches with the name of digital print files pre-defined as subject to print control,
interrupting printing, if there is a match.

9. The method of claim 8 comprising storing the names of digital print files pre-defined as subject to print control in a remote or local store accessible to the 3D printer or for downloading to the memory of the printer.

10. The method of claim 8 wherein the names of digital print files pre-defined as subject to print control are stored in a central location and accessible by the 3D printer.

11. The method of claim 1 wherein providing details of objects pre-defined as subject to print control to the controller further comprises:
performing a hash of digital print files pertaining to objects pre-defined as subject to print control;
storing the hash data;
upon receipt at the printer of a print request and an input digital print file (DPF) representative of an object to be printed;
performing a hash on the received input digital print file;
comparing the hash of the input digital print file which stored digital print file hashes;
determining whether there is a match between the hash of input digital print file and the stored digital print file hashes of pertaining to objects predefined as controlled;
interrupting printing if there is a match.

12. The method of claim 1 wherein the method is a computer implemented method.

13. A computer program product for controlling printing of an object by a 3D printer, the computer program product comprising computer readable instructions that when loaded into a memory of a computing device and executed, cause the computing device to perform the method according to claim 1.

14. A system for controlling the 3D printing of an object by a 3D printing apparatus comprising:
a build module having a build platform and 3D printing module for building an object;
a controller configured to receive a digital print file (F) which includes data representative of the object to be printed, including layer by layer information;
the controller further configured to receive details of objects predefined as subject to print control;
the controller further comprising a 3D object analyser;
wherein the controller is configured to build a representation of the object to be printed; and
wherein the 3D object analyser is configured to interrogate the representation of the object to be printed to determine whether the object includes a possible match to a feature of an object predefined as subject to print control;
if it is determined by the object analyser that the object to be printed includes a possible match to one or more features that correspond to features of a pre-defined controlled object; the controller is configured to: (i) effect further interrogation of the object to be printed to determine whether the object to be printed includes a possible match to more than one feature of an object predefined as subject to print control; and/or (ii) to interrupt printing.

15. The system of claim 14 wherein the representation of the object that is interrogated by the object analyser is a three dimensional 3D representation.

16. The system of claim 14 wherein the representation of the object that is interrogated by the object analyser is a 2D representation wherein the geometry has been sliced into layers to be sent to the 3D printer, the geometry being represented by a series of two dimensional (2D) profiles.

17. A method for controlling the 3D printing of an object by a 3D printer:
providing 3D printing apparatus having a printing module and build module and a print controller;
storing file data of digital print files pertaining to objects pre-defined as subject to print control in memory, wherein the store may be remote, cloud based, or local and wherein the stored data is accessible by the printer or may be downloaded to the printer;
providing a hash algorithm to the printer to allow the printer perform a hash of a received digital print file;
upon receipt at the printer of a print request and an input digital print file (DPF) representative of an object to be printed;
performing a hash on the received input digital print file;
comparing the hash on the input digital print file which the stored digital print file hashes;
determining whether there is a match between the hash of input digital print file and the stored digital print file hashes pertaining to objects predefined as controlled;
interrupting printing if there is a match.

18. The method of claim 17 further comprising the displaying an indication that an object to be printed has been determined to show a possible match to features pre-defined as subject to control.

19. The method of claim 17 further comprising receiving confirmation that printing is allowed whereupon the controller instructs the 3D printing module to print the object, or, that printing is prevented.

20. The method of claim 19 wherein the confirmation is provided by a supervisor.

21. The method of claim 17 wherein hash function is used to determine if the file received in a print request from a user has been modified.

22. The method of claim 17 wherein the hash is produced using a fuzzy hashing algorithm or fuzzy extractor.

23. The method of claim 22 wherein the fuzzy hashing algorithm is configured to produce the same hash value for data sets that may be significantly different, but which are directed to command the printer to build an object pre-defined as subject to a print control.

24. A system for controlling the 3D printing of an object by a 3D printing apparatus comprising:
a build module having a build platform and 3D printing module for building an object;
a controller configured to receive a digital print file (F) which includes data representative of the object to be printed, including layer by layer information;
the controller further configured to access or receive details of objects predefined as subject to print control, wherein the details comprise file names or hash function of the files;
the controller further configured to receive a hash algorithm to the printer to allow the printer perform a hash of a received digital print file;
the controller performing a hash of a received digital print file;
the controller comparing the name and the hash of a received digital print file with those indicated as being subject to print control;
if it is determined that there is a match between the file name or hash function of the received digital print file and of those indicted as being subject to print control;
the controller is configured to: (i) interrupt printing or (ii) prevent printing.

25. The system of claim 24 wherein the hash algorithm comprises a fuzzy hashing algorithm or fuzzy extractor such that the fuzzy hashing algorithm is configured to produce the same hash value for data sets or digital print files that may be significantly different, but which are directed to command the printer to build objects that are in at least some important respects identical to the original protected object/the object pre-defined as subject to a print control.
